(19) United States
(12) Patent Application Publication
(10) Pub. No.: US 2019/0070787 A1
(43) Pub. Date: Mar. 7, 2019

(54) MACHINE LEARNING ENABLED MODEL FOR PREDICTING THE SPREADING PROCESS IN POWDER-BED THREE-DIMENSIONAL PRINTING

(71) Applicants: William Marsh Rice University, Houston, TX (US); Carnegie Mellon University, Center for Technology Transfer and Enterprise Creation, Pittsburgh, PA (US)

(72) Inventors: C. Fred Higgs, III, Houston, TX (US); Prathamesh S. Desai, Houston, TX (US)

(73) Assignees: William Marsh Rice University, Houston, TX (US); Carnegie Mellon University, Center for Technology Transfer and Enterprise Creation, Pittsburgh, PA (US)

(21) Appl. No.: 16/101,193

(22) Filed: Aug. 10, 2018

Related U.S. Application Data
(60) Provisional application No. 62/605,354, filed on Aug. 10, 2017.

(51) Int. Cl. B29C 64/393; B33Y 50/02; G06F 17/50; G06N 3/04

(52) U.S. Cl. CPC B29C 64/393; B33Y 50/02; G06F 2217/16; G06N 3/04; G06F 17/5009

(57) ABSTRACT

A method of generating parameters to guide a spreading process of a three dimensional printer may include the following steps: determining one or more properties of an actual powder; generating a virtual powder model which mimics the actual powder; performing one or more virtual spreading simulations; experimentally validating virtual spreading; and using advanced regression techniques to generate spreading process map from a few virtual spreading simulations.

### CROSS-REFERENCE TO RELATED APPLICATIONS

This application claims the benefit of provisional application No. 62/605,354, filed on Aug. 10, 2017, which is incorporated by reference in its entirety.

### BACKGROUND

Powder-bed additive manufacturing (AM), or three-dimensional (3D) printing, is slated to disrupt the traditional manufacturing industry, which is predominantly dependent on casting, molding, and subtractive manufacturing. 3D printers may be used to manufacture three-dimensional objects from metallic powders, through repetitive spreading of layers of powder and selective fusing or binding of powder particles in each layer. This procedure is described in more detail below.

3D printing is generally performed in four repeated steps, illustrated in FIGS. 1a-1d. FIG. 1a illustrates a first step in which a powder 152 is delivered from a hopper 154 to a stationary platform 156 of a 3D printer 150. The powder may be any type of powder known in the art, especially a metallic powder. FIG. 1b illustrates a second step in which the powder 152 is spread by a spreader 158. The spreader 158 may move in two dimensions to spread the powder 152 over a partially formed product 160 disposed on a mobile platform 162. FIG. 1c illustrates a third step in which portions of the powder 152 are bonded by a binding arrangement 164. The binding arrangement 164 may comprise an energy beam, such as a laser or electron beam, or a fluidic binding mechanism. The portions of the powder 152 which are bonded may form part of the product 160. The portions of the powder 152 which do not form part of the product 160 may be left unbound. FIG. 1d illustrates a fourth step in which the mobile platform 162 is moved downwards. The distance which the mobile platform 162 moves downward may be determined by a height of the layer formed by the powder 152. Steps one through four may be repeated until an entire product 160 is formed.

State-of the art 3D printers are optimized to work with only a handful of materials. 3D printing a new material usually requires iteratively testing different standard machine settings until the combination which provides the best product is found. This process may require large amounts of material and time, and may therefore be expensive. Further, the parts manufactured using such printers have rough exteriors and porous interiors. Accordingly, advances in the steps described above are desired. Most of the existing 3D printing research focuses on optimizing the bonding process, i.e. step three. Powder spreading, i.e. step two, is rarely studied. However, uniform spreading of powder layers is necessary to 3D print dense and isotropic parts with a smooth surface finish.

Advances are still necessary to improve the spreading of powder in 3D printing. In particular, methods and equipment which enable 3D printers to readily manufacture products from a variety of materials, and to form products with desirable characteristics, such as dense and isotropic parts with a smooth surface finish, are still needed.

### SUMMARY OF THE DISCLOSURE

This summary is provided to introduce a selection of concepts that are further described below in the detailed description. This summary is not intended to identify key or essential features of the claimed subject matter, nor is it intended to be used as an aid in limiting the scope of the claimed subject matter.

The present disclosure relates generally to methods and equipment for 3D printing. Embodiments of the present disclosure may overcome shortcomings of previous 3D printing technologies, for example by improving the ease with which new powders may be used to 3D print products, and improving the quality of 3D printed products. Embodiments of the present disclosure may include improvements to the spreading of powder during 3D printing processes.

In one aspect, this disclosure relates to a method of generating parameters to guide a spreading process of a three dimensional printer which may include the following steps: determining one or more properties of an actual powder, generating a virtual powder model which mimics the actual powder; performing one or more virtual spreading simulations; experimentally validating virtual spreading; and using advanced regression techniques to generate spreading process map from a few virtual spreading simulations.

In another aspect, this disclosure relates to a three-dimensional printer which may be configured to print a product from a powder, and may be configured to receive parameters to guide the spreading process. The parameters may be determined by a process including the following steps: determining one or more properties of an actual powder, generating a virtual powder model which mimics the actual powder, performing one or more virtual spreading simulations; experimentally validating virtual spreading; and using advanced regression techniques to generate spreading process map from a few virtual spreading simulations.

Other aspects and advantages will be apparent from the following description and the appended claims.

### BRIEF DESCRIPTION OF DRAWINGS

FIGS. 1a-1d are a 3D printer in accordance with the prior art.

FIG. 2 is a flow chart in accordance with the present disclosure.

FIGS. 3a-3b are sample holders in accordance with the present disclosure.

FIG. 4 is a flow chart in accordance with the present disclosure.

FIG. 5 is a flow chart in accordance with the present disclosure.

FIG. 6 is a flow chart in accordance with the present disclosure.

FIG. 7 is a schematic view of a 3D printer and powder particles in accordance with the present disclosure.

FIG. 8 is a schematic view of a neural network in accordance with the present disclosure.

FIG. 9 is the physics-based model result in accordance with the present disclosure.

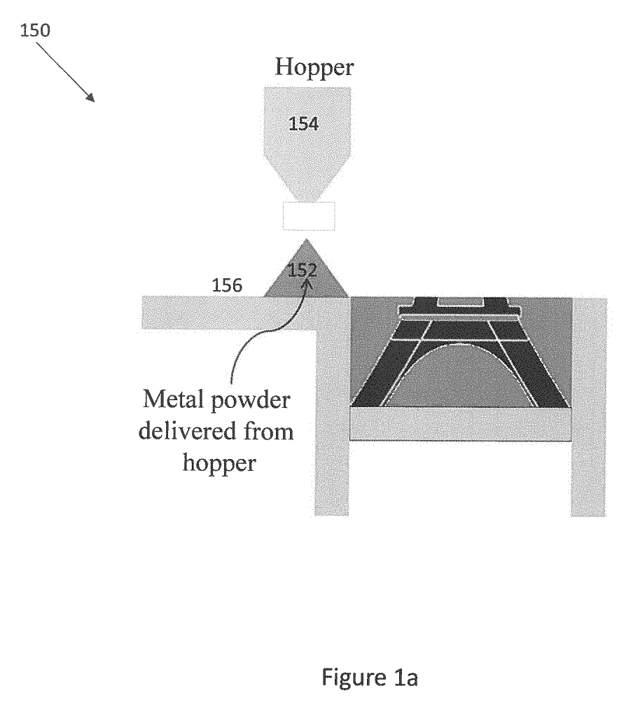

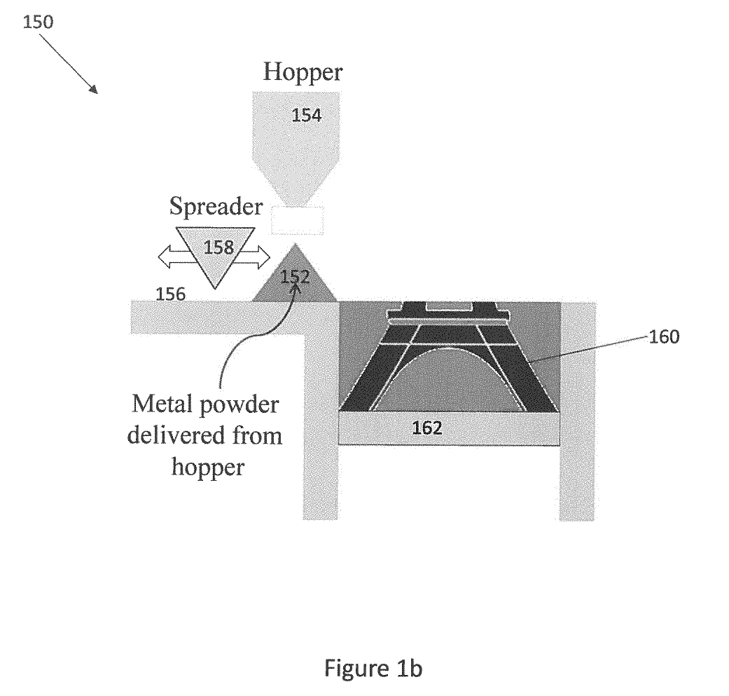

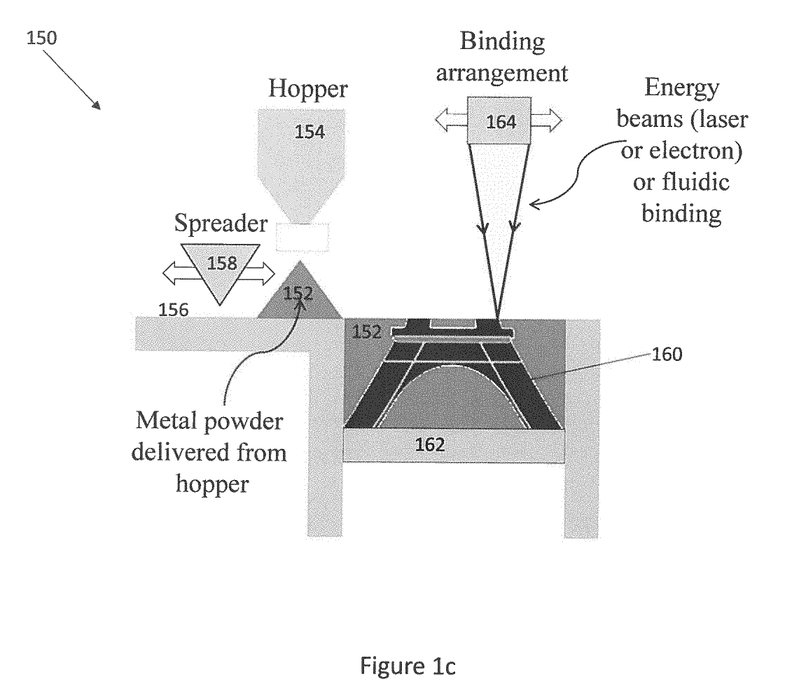

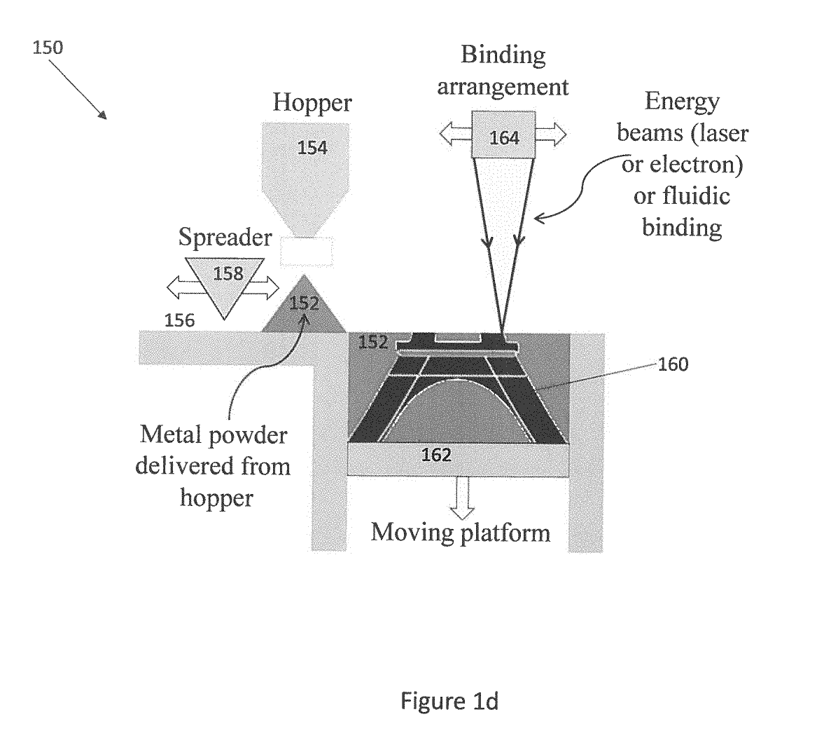

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

As used herein, the term “coupled” or “coupled to” or “connected” or “connected to” may indicate establishing either a direct or indirect connection, and is not limited to either unless expressly referenced as such. Wherever possible, like or identical reference numerals are used in the figures to identify common or the same elements. The figures are not necessarily to scale and certain features and certain views of the figures may be shown exaggerated in scale for purposes of clarification.

Embodiments of the present disclosure relate generally to methods and equipment for additive manufacturing (AM) or three-dimensional (3D) printing. Creating parts through AM within acceptable tolerances for surface roughness and porosity is contingent upon many process variables. One of these process variables is the ability to spread uniform layers of loose powder for a given thickness over a given coverage area. This ability depends on the ‘spreading recipe,’ or the spreader shape, spreader velocity and layer height which results in the desired porosity and surface roughness of the 3D printed part. This spreading recipe varies from powder to powder and application to application. For example, some applications will need the 3D printed part to be least porous while having rough surface and few others might need the part to have least roughness but larger porosity. The spreading recipe may also be a function of roughness of the substrate on which the powder is being spread. The spreading recipe may relate to the ‘spreadability’ of powders or the study of flow and spread of powders under a giving loading.

Embodiments of the present disclosure relate generally to methods and equipment for 3D printing. The methods and equipment disclosed herein may enable a 3D printer to readily manufacture products using a variety of powders, including powders whose identity is not known, and powders which have not previously been 3D printed. The methods and equipment may improve the spreading of powder layers during a 3D printing process and may allow a product with desired characteristics to be manufactured. The methods and equipment may present improvements in the 3D printing process, especially in spreading powder layers, as compared to state of the art methods and equipment. They may make use of the ‘spreading recipe’ and/or ‘spreadibility’ of a particular powder.

In one aspect, the present disclosure relates to a method for determining printer settings for 3D printing a product from a powder. In another aspect, the present disclosure relates to a method for manufacturing a 3D printed part from a powder. A method for manufacturing a 3D printed part from a powder may include a method of determining printer settings.

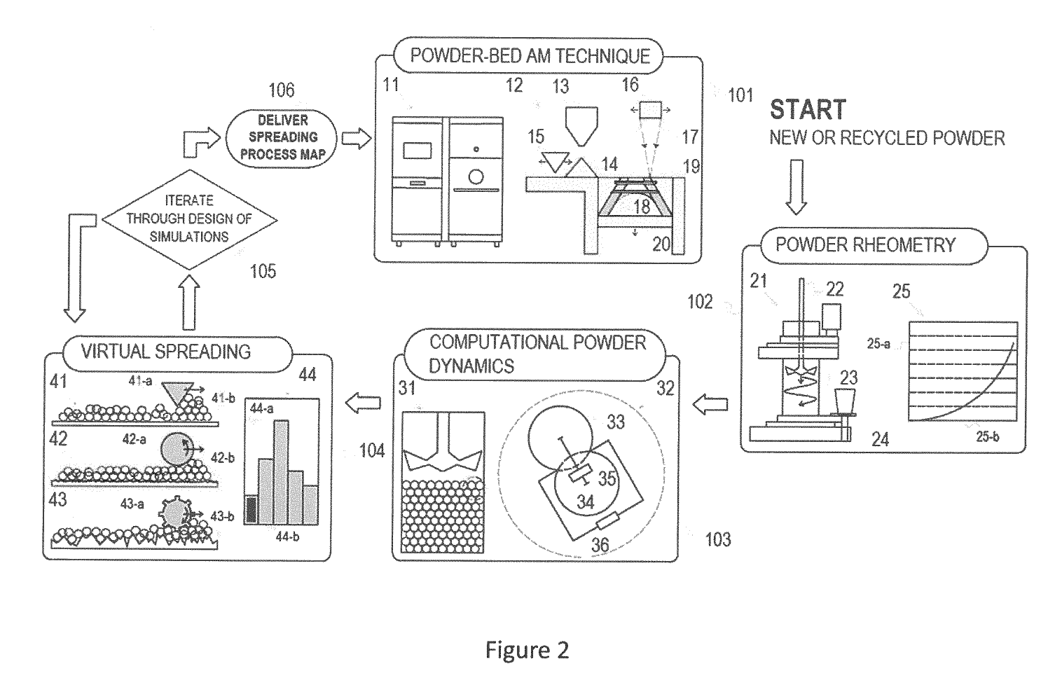

FIG. 2 shows the steps involved in obtaining powder-and-application specific spreading recipes via the generation of spreading process maps, and using those recipes to manufacture a 3D printed product. The process of generating maps and obtaining spreading recipes may include three steps: powder rheometry 102, computational powder dynamics 103, and virtual spreading 104. The virtual spreading step 104 may be performed iteratively using different parameters in an iteration step 105. The process of manufacturing a 3D printed product may include two additional steps: spreading map delivery 106 and printing 101.

The powder rheometry step 102 may include the characterization of the powder using a typical rheometer 21. A rheometer is used to study the rheology of powder. Rheology involves the scrutiny of flow of powder under different loadings. A typical rheometer may involve a blade 22 which is made to penetrate through a cylindrical vessel 23 containing the powder. The cylindrical vessel is held in place by the assembly 24. The blade may undergo a downward, rotational motion which compresses the powder. A typical output from a typical rheometer 21 may involve the energy required to penetrate through the bulk of the powder being characterized. This is shown in plot 25, the Y-axis 25a of which is the energy required by the blade to traverse height shown on X-axis 25b. This energy response varies from powder to powder and captures the constitutive behavior of the powder.

Although the powder rheometer 21 may characterize powders as described above, it may not be able to directly study the ‘spreadability’ of powders. However, it does provide important properties required to quantify ‘spreadability’ when used in tandem with powder computational models. These properties may include the angle of internal friction and loading specific flow energy requirements of the candidate powders.

The computational powder dynamics step 103 may include the use of powder computational models to determine powder properties. An overall goal of this step 103 may be to develop a virtual model of a powder which matches the actual powder measured in the previous step 102. Calculations performed during this step may be based on the Discrete Element Method (DEM) which involves the Lagrangian principles as opposed to continuum modeling, which is based on the Eulerian approach. DEM best suits the study of powder spreadability as it can inherently capture powder layer quality descriptions such as segregation, porosity and surface roughness. A two-step validation process is carried out to obtain a virtual powder bulk comprising of spherical and uncrushable particles. The first step may involve the validation of qualitative behavior of the virtual powder bulk by performing virtual angle of repose tests. This is followed by the second step which may validate the quantitative behavior of virtual powder bulk by performing virtual rheometry as shown in virtual rheometer 31. Particle level contact model occurring inside virtual rheometer 31 is shown in diagram 32. Contact forces occurring in between any two particles 33 and 34 may be resolved using the deformation-based force models 35 and 36 along normal and tangential directions respectively. These models may be as simple as a linear spring-dashpot model or complicated like a hysteresis model, or may be any type of model known in the art. Any contact model may have to undergo a calibration process which may involve a tuning of micro-parameters, of which the force models are a function, to obtain a virtual bulk which behaves qualitatively and quantitatively similar to the real powder which was tested in step 102. This two-step validation process thus involves a feedforward iterative testing of different set of micro-parameters satisfying first, qualitative and then, quantitative powder traits. The calibration process may stop when the powder-specific experimental criteria of angle of repose, which is a function of angle of internal friction, and flow energy are met. This virtual bulk may be further validated for its response to different blade speeds without any more calibration.

The virtual powder bulk obtained from computational powder dynamics step 103 may be used to carry out spreading simulations and study the spread layer properties in the virtual spreading step 104. A goal of this step 104 may be to determine the properties of spread layers of the virtual powder for which a model was developed in the previous step 103. Front views of a typical spreading simulation are shown in virtual spreading schematics 41, 42 and 43 with different spreader shapes 41a, 42a and 43a having translational and rotational speeds as indicated by the arrows. These spreaders may spread the virtual powder bulk obtained from step 103 over substrates 41b, 42b and 43b having varying roughness. In some embodiments, spreader shapes with varying roughness, similar to the spikes of 43b, may be used in this simulation. The computational powder dynamics model used in step 103 may be general enough to account for any spreader shape and any substrate roughness. Optical profilometry may be used to measure roughness of real 3D printed substrate and this roughness may then be used to generate virtual substrates like 41b, 41b and 43b used in the virtual spreading simulations. These simulations using the virtual powder bulk may accurately capture the amount and angle of the powder pile-up at the end of each spread (powder heap in front of the spreader, seen in schematic 41, 42 and 43) as this may be reminiscent of the virtual angle of repose testing in step 103. These simulations may also accurately capture the layer porosity resulting due to the loading of powder due to the blade as this is reminiscent of the virtual rheometry in step 103. Roughness of the spread-layer may be extracted by plotting heights occupied by particles over the spread area as in graph 44 with heights plotted along X-axis 44a and number of particles occupying a certain height plotted along Y-axis 44b.

The virtual spreading step 104 described above may be performed iteratively, through a Design of Simulations approach 105. A goal of this approach may be to identify a set of 3D printer parameters which gives a spread powder layer with preferred properties. The 3D printer parameters may include spreader shape, spreader angular velocity, spreader translational speed, layer height and roughness of substrate and/or sub-layer. The spread powder layer properties may include particle density, layer roughness, layer porosity, and spread throughput.

The design of simulations approach 105 may be used because the particle sizes of AM powders may vary from tens to a few hundreds of microns, and therefore, simulations run in step 103 and step 104 must include a large number of particles. Accordingly, a large number of computations must be performed. These computations, though large in number, may be simple enough to be carried out on a slower processor. This type of computational burden may be economically tackled by parallelizing the DEM model to work on GPU (Graphics Processing Unit) comprising of thousands of less powerful processors instead of CPU with few highly powerful processors. A typical powder dynamics simulation of a million particles, which has been highly parallelized using GPUs (i.e., Graphics Processing Units), can take about 24 hours of computational time to simulate few seconds of real time. An iterative parametric study for various spreader shapes and velocities for varying height of spreader from substrate on substrates having different roughness values may be carried out by using the Design of Simulations approach 105 to reduce the number of simulations to be carried out. This approach may be similar to the concept of Design of Experiments used to reduce the number of experiments to be carried out. These spreading simulations 104 may be used to study the spread layer roughness, the spread layer porosity, the volume of powder spread per unit time per unit width of spreader or the spread throughput, and other properties of the spreading which would be performed by a 3D printer. Iteration 105 may continue with repeated performances of step 104 until a pre-determined set of simulations has been tested, until desired spread properties have been found, or until some other criteria has been met.

As discussed above, the determination of a set of 3D printer parameters may represent the conclusion of a method to create a spreading process map. In some embodiments, the spreading process map may be output to guide a 3D printer's printing process. In some embodiments, the physics-based and machine learning modeling simulation, from which the process map would be generated, may be directly used as software to guide the printer's spreading process. A method to 3D print a product from a powder may include those steps described above, and may further include the steps described below.

In the map delivery step 106, spreading process maps based on simulation results from steps 104 and 105 may be made available to a 3D printer operator by using sophisticated interpolation techniques from the science of machine learning. In some embodiments, methods other than machine learning may be used in this step. The laser and electron beam based AM techniques result in striated 3D printed surfaces due to the uneven temperature distribution in the energy beams. One way to 3D print a smooth and uniform product is to forcibly introduce roughness in the spread layer which can negate the drawbacks of uneven heating and melting in the beam-based 3D printers. Spreader shape 43a may produce a striated spread layer which when acted on by passes of energy beams with uneven temperature distribution can result in a smooth and uniform build layer. The spreading process maps delivered in step 106 may allow a 3D printer operator or software to decide how to purposely introduce this spread layer roughness.

A 3D printer may print a product from a powder using the spreading process maps in the printing step 101. Step 101 shows the powder-bed AM technique, showing a general powder-bed 3D printer 11 and the 3D printing process 12 occurring inside the printer 11. Generally, a 3D printing process 12 may involve the delivery of powder via a hopper 13. The powder heap 14 formed after powder delivery may then be spread into a fine layer using a spreader 15. Properties related to the spreader 15 and the spreading process may be chosen based on the spreading process map delivered in step 106. These properties may be chosen so that the spread layer has certain desired properties. The spread layer may then be fused by the scanning arrangement 16 using energy beams 17, which may be laser or electron beams. The energy beam 17 may also represent ink jet fluidic binding. The fusion may occur at the predetermined locations 18 which may be presented in the CAD file of the geometry being 3D printed. In some embodiments, the locations may be delivered by a different means. The remaining locations 19 are occupied by unfused powder. The moving platform 20 then descends by a single powder layer thickness and the process is repeated until the entire geometry is 3D printed.

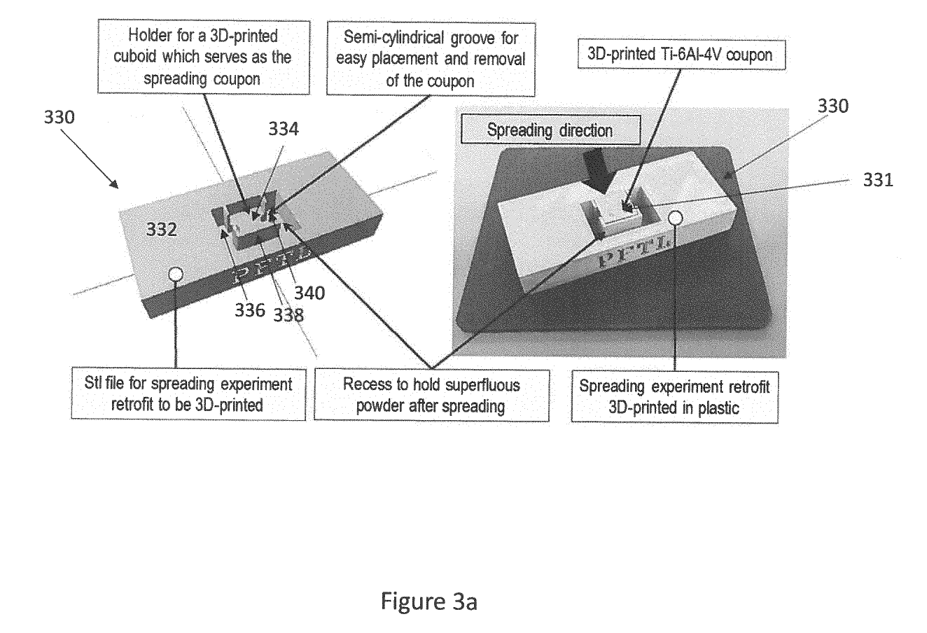

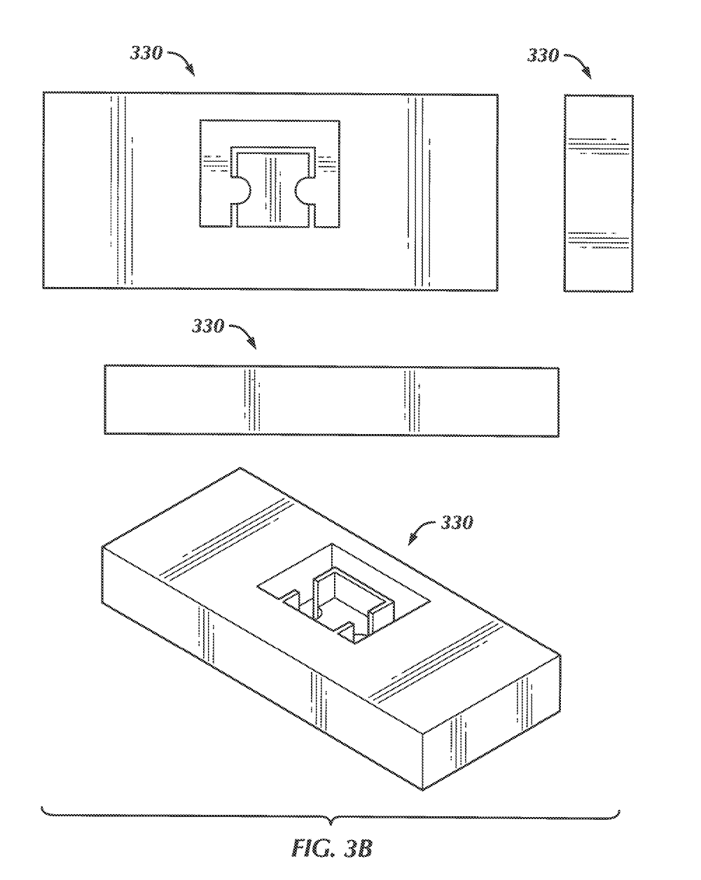

In some embodiments, a small test piece may be printed from a powder using the spreading process maps in the printing step 101 before the entire product is printed. A sample spreading set-up 330 is illustrated in FIGS. 3a-3b. The sample spreading set-up base 332, a sample platform 334, and a recess 336. A previously 3D printed sample 331 may be placed on the sample platform 334, and used as a spreading test coupon on which single layer of powder will be spread. Excess powder may be captured in the recess 336. The spreading test coupon 331 may be surrounded by walls 338 which include a groove 340 to allow for easy removal of the coupon. The coupon may have the same properties such as roughness and porosity that a full product would have. This may allow the spreading maps generated via the process described above to be verified using a small amount of powder in a short time.

In another aspect, the present disclosure relates to a 3D printer for manufacturing a product from a powder. The 3D printer may implement any of the processes described above. In some embodiments, some of the processes may be implemented on a computer which is separate from the 3D printer. Spreading process maps generated on the computer may be delivered to the 3D printer, which may in turn implement the process maps via a graphic user interface or some type of user-defined programming function, controlling the actuation of the spreader, for various powders in 3D printing a product. The 3D printer may be any type of printer known in the art.

The processes above have been described in general terms. Exemplary embodiments of these processes will now be described below, with reference to FIGS. 2 and 4-7. The exemplary processes described below will make reference to the steps described above: powder rheometry 102, computational powder dynamics 103, virtual spreading 104, iteration 105, spreading map delivery 106, and printing 101.

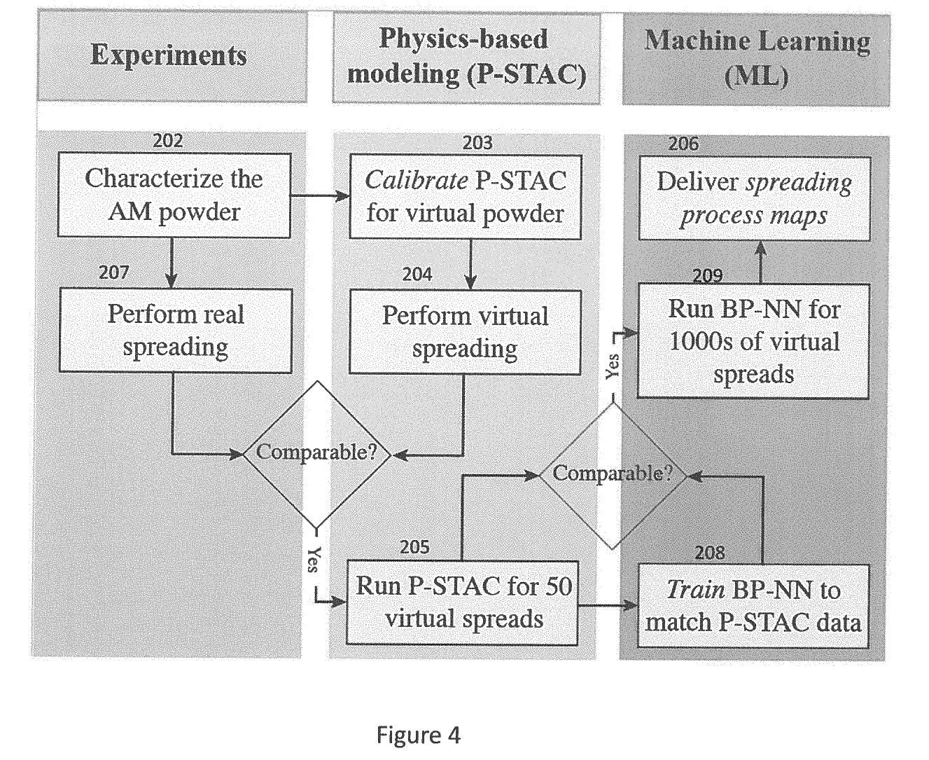

FIG. 4 illustrates a flow chart of the experimental method, which is similar to the methodology presented in FIG. 2. The methodology illustrated here is used because problem of studying the spreadability of AM powders is twofold: firstly, it is difficult to study this problem experimentally inside a real 3D printer, due to the difficulty involved in characterizing the spread layer parameters without interfering with the environmental conditions required for working with Ti-6Al-4V powder, a common powder used in 3D printing which is used in this exemplary process. The safety issues associated with the handling of AM powders such as toxicity, flammability and explosivity make a trial-and-error approach, common with experimental studies, unrealistic and unsafe. This first problem makes the experimental study not only difficult but also expensive. Secondly, computational study of this problem is also not trivial as the DEM, most well suited among other computational techniques, is based on Lagrangian principles and has no simple constitutive laws for AM powders.

Because of the considerations described above, a synergistic, three-phase approach as shown in FIG. 4 may be used to predict spreadabilty of AM powders. This synergistic approach may include some or all of the steps described above with respect to FIG. 2. The first phase may be experimental. The AM powder may be characterized using a powder rheometer in step 202. Real spreading experiments, i.e. step 207, may or may not be performed. The second phase may use physics-based modeling. A model for a virtual powder which behaves similarly to the real AM powder may be calibrated in step 203 and used to perform virtual spreading in step 204. The model powder calibrated in step 203 may be compared to the real powder measured in step 202 and/or the results of the virtual spreading in step 204 may be compared to the results of the real spreading in step 207. If the chosen pair of virtual and real properties are similar, a series of virtual spreads may be performed in step 205 using the virtual powder model. In some embodiments, fifty virtual spreads may be performed. The experimental phase may also experimentally validate the models used in the modeling phase. The third phase may use machine learning. The results of the virtual spreads performed in step 205 may be used to train and test regression algorithms based on machine learning, e.g., back propagation neural networks (BP-NN) in step 208. If the algorithm is successfully trained, it may be used to generate thousands of virtual spreads in step 209 and to deliver the results of those spreads as spreading process maps in step 206. These maps may show the relations between 3D printer operator's input parameters e.g., spreader shape-and-speeds, and spread layer parameters.

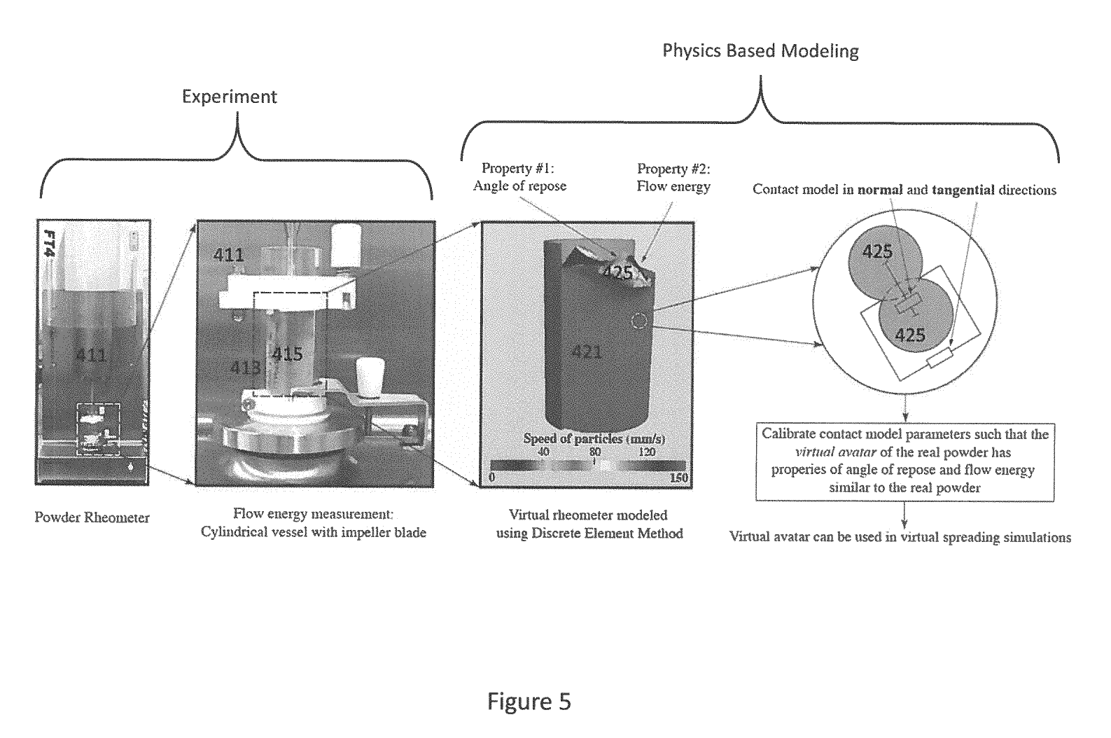

FIG. 5 illustrates the relationship between the experimental phase and the physics based modeling phase. Experimentally, flow energy measurements may be taken using a rheometer 411. The rheometer 411 may include a cylindrical vessel 413 with an impeller blade 415 disposed inside. A virtual rheometer 421 may be modeled based on the actual rheometer 411 using the Discrete Element Method (DEM). The virtual rheometer 421 may be used to measure the angle of repose and the flow energy of virtual powder particles 425. The model of the virtual powder particles 425 may include the normal and tangential contact models between the particles 425. Parameters of the virtual powder particles 425 may be calibrated using DEM such that the virtual powder particles 425 have an angle of repose and a flow energy in the virtual rheometer 421 similar to the angle of repose and flow energy of the real particles measured by the real rheometer 411.

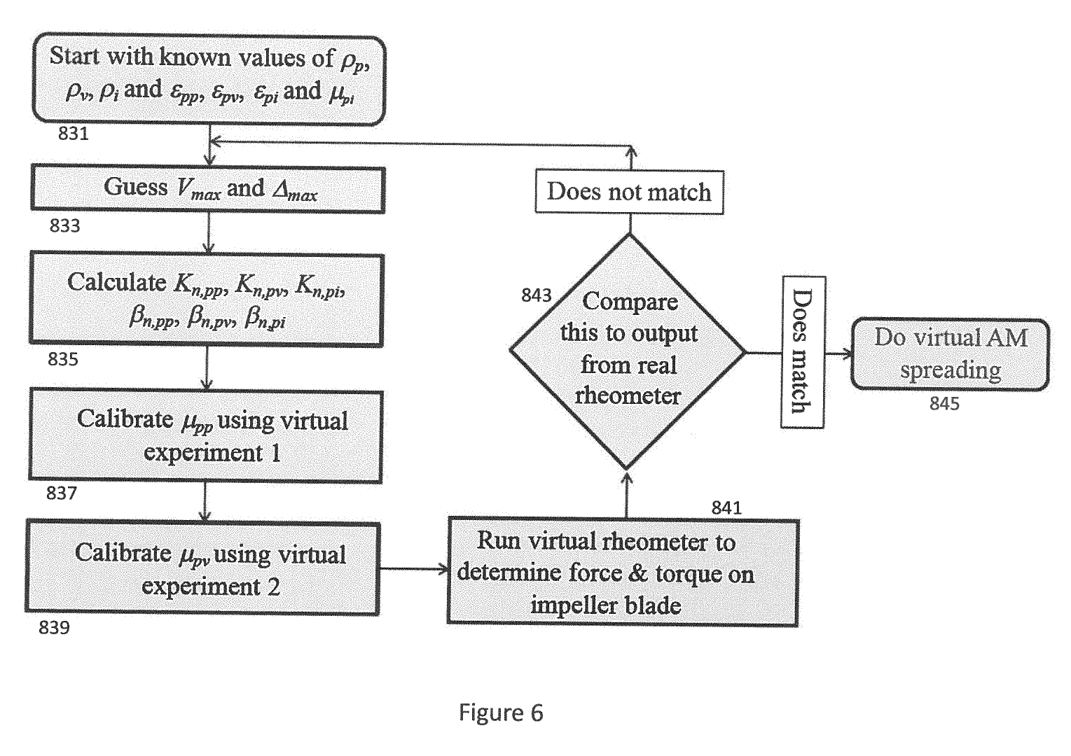

FIG. 6 illustrates a sample algorithm for the physics based modeling phase in more detail. Values for coefficients of restitution, coefficients of sliding friction, and mass densities of the particle in a particulate media may be known in an initial step 831. In a second step 833, values for the maximum speed and an overlap of a particle with another particle or geometry may be guessed. In a third step 835, stiffness and damping may be calculated. In a fourth step 837, a first virtual experiment may be run to calibrate a first friction coefficient. In a fifth step 839, a second experiment may be run to calibrate a second friction coefficient. In a sixth step 841, a simulation of the virtual rheometer may be run to determine force and torque on a virtual impeller blade. In a seventh step 843, the output of the virtual rheometer may be compared to the output of the real rheometer. If the values match, or if the difference between the values is less than a predetermined threshold, virtual spreading simulations 845 may be performed. If the values do not match, steps two through seven may be repeated.

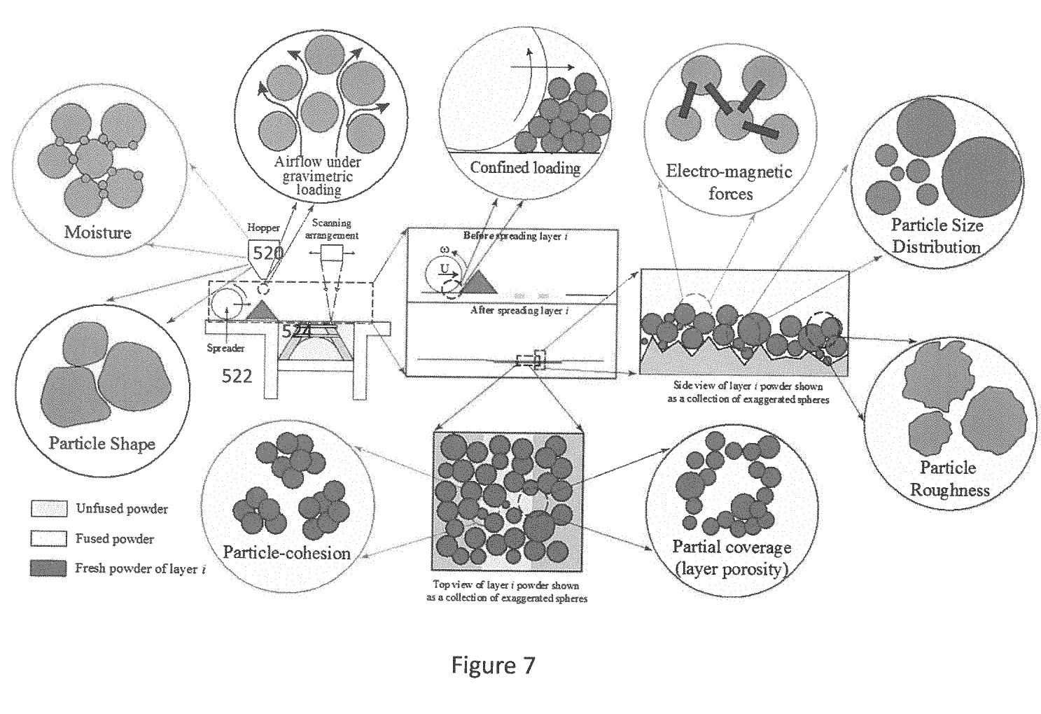

FIG. 7 shows an exploded view of all the attributes of all the phenomena or physics of contact mechanics, particle mechanics and fluid mechanics which can be encountered while trying to understand the powder's flowability or the ability to flow under gravimetric loading (e.g., delivery of powder from the hopper 520) and spreadability or the ability of an AM powder to spread under a giving load (e.g., the confined loading of the AM powder in front of the spreader over a substrate 524). The particle mechanics attributes of shape, hydrophilic or hydrophobic behavior and fluid mechanics attributes like aeration ability of powder particles or the ease at which the powder particles can enter the airflow of a room, are important during the powder delivery step. Then during the spreading step, as can be seen in the side and top views of layer i, particle mechanics attributes like particle roughness, particle size distribution, particle cohesion and electro-magnetic behavior of the powder particles can be of significance to understand the spread layer roughness and layer porosity or partial coverage. Some or all of these attributes may come into inside a powder-bed 3D printer 522.

This description will now return to a specific exemplary embodiment of the methods illustrated in FIGS. 2-3. A DEM may be used to simulate the powder spreading process in AM. The exemplary DEM makes use of uniformly sized, 235,000 smooth spherical, cohesionless elements of 250 microns diameter to represent the AM powder, which approximate the properties of a Ti-6Al-4V powder, one of the commonly used powders in AM. One skilled in the art will recognize that any type of particles may be used in this method, and those described here are only exemplary. This example also makes use of an ideally smooth substrate.

The DEM code is parallelized to run on a Graphics Processing Unit (GPU). There are two different types of collisions involved in the simulation of powder spreading in AM, namely powder particles colliding with other powder particles and powder particles colliding with the solid surfaces of the spreader. Each type of collision has its own computational challenges. The former particle-particle collision requires an efficient neighborhood search, while the latter, particle-surface collision, requires an accurate representation of the surface geometry. The neighborhood search is the most time-consuming step in a DEM simulation. Hence, a verlet-based efficient neighborhood search algorithm is employed using a technique called ‘spatial binning’ to further improve the performance of the solver. Again, one skilled in the art will recognize that the DEM code could be run in any manner on any type of computer known in the art.

The contact model used in this exemplary embodiment may consist of two damped Hookean springs, one in the normal direction (subscript n) and the other in the shear or tangential direction (subscript t). Particles may be modeled in other ways without departing from the scope of this disclosure. These springs are illustrated in the final panel of FIG. 5. Their behavior may be governed by the following equations:

$$\begin{matrix}{K}_{n} = \frac{{f}^{2} {m}_{eq} {V}_{m a x}^{2}}{{φ}^{2}} ; f = \frac{φ}{{Δ}_{ma x}} & ( 1 ) \\ {β}_{n} = - 2 {ln ( ɛ ) [ \frac{{K}_{n} {m}_{eq}}{{π}^{2} \{ ln ( ɛ ) \}} ]}^{1 / 2} & ( 2 ) \\ \underline{{F}_{n}} = {K}_{n} \underline{{Δ}_{n}} - {β}_{n} \underline{{Δ}_{n}} & ( 3 ) \\ \underline{{F}_{t}} = - μ \vert \underline{{F}_{n}} \vert \underline{{e}_{t}} & ( 4 )\end{matrix}$$

where K and β stand for stiffness and damping respectively. Here m_{eq} stands for the equivalent mass of colliding particles, having diameter [symbol] and constant coefficient of restitution [symbol] which is independent of impact velocity. This m_{eq} is one half of the harmonic mean of the individual masses. Vₘₐₓ and [symbol] are the estimated maximum speed and inter-particle penetration respectively for the simulation at hand. These values are usually guessed. A slider is also present in the shear direction. It limits the maximum frictional force in this direction, the value of which is equal to the product of sliding friction coefficient [symbol] and the normal reaction force Fₙ (given by Eq. 3). It is assumed that all the interactions cause particles to slide thereby nullifying the tangential damped Hookean spring. In other words, only the slider acts in the shear direction. Therefore, the forces along the normal (Fₙ) and tangential (Fₜ) directions experienced by a colliding particle with an overlap of Δ with other particle or solid surface geometry, relative approach speed of \dot{Δ} and unit vector in shear direction as e̅ₜ̅ can be represented by equations (3) and (4). These equations may be used as the DEM module of software used to perform spreading simulations as described below.

Spreading simulations may require a set of contact force parameters which can make the virtual powder bulk behave in ways similar to a real AM powder. The density of these spherical particles is 4430 kg/m₃ and is equal to the real AM Ti-6Al-4V powder. The DEM parameters used in this embodiment are summarized in Table 1. 45 simulations are conducted using an n-factorial design of simulations (DoS) approach on the lines of design of experiments approach. The different parameters for spreading simulations, involving a roller as a spreader, are summarized in Table 2. The substrate is assumed to be perfectly smooth. These ranges in spreader speeds approximately cover the speeds seen on a real 3D printer.

TABLE 1
DEM parameters used in spreading simulations

| | Ti—6Al—4V powder interacting with | | |
|---|---|---|---|
| | | 3D printed | Ti—6Al—4V |
| Property | spreader | substrate | powder |
| ε | 0.8^{#} | 0.8^{#} | 0.8^{#} |
| μ | 0.12^{@} | 0.25^{#} | 0.185* |

*=> value tuned via the DEM calibration process.
^{@}=> value measured using rheometer,
^{#}=> assumed value

TABLE 2
Design of Simulations (DoS) for virtual spreading

| Parameter | Value(s) |
|---|---|
| Spreader diameter (mm) | 10 |
| Spreader length (mm) | 70 |
| Spreader translation speed, U | 40, 55, 70, 85, 100 |
| (mm/s) | |
| Spreader rotation speed, ω (rad/s) | 0, 5, 10, 15, 20, −5, −10, −15, −20 |

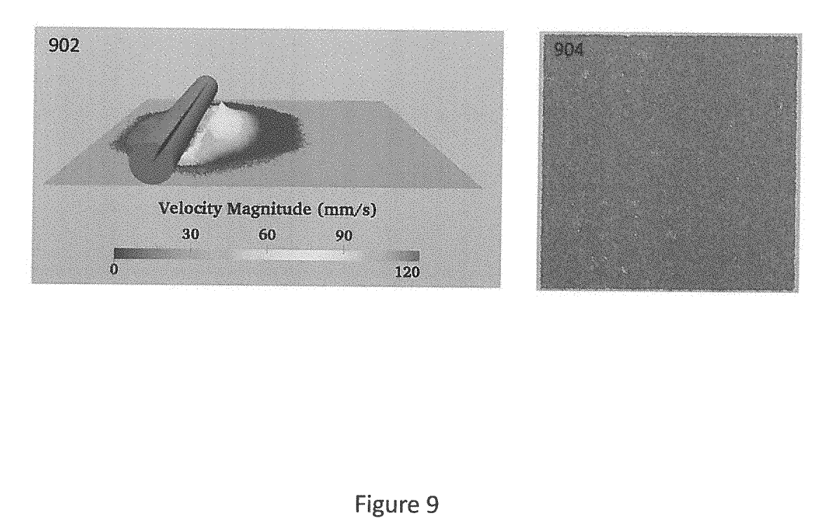

FIG. 9 shows a sample simulation snapshot 902 for virtual spreading with roller having U=100 mm/s and ω=0 on a flat substrate. Particles are colored by values of their velocity magnitude. Also shown is the post-spread region 904 as described below.

The spread layer created by the simulation described above may be characterized as follows. A 50 mm×50 mm region centrally located above the substrate 904, after the spreading simulation has completed, is sampled for two important properties: volume of powder spread per unit time per unit width of the spreader or the spread throughput, Vs, and the roughness of the spread layer, Rq. Vs may be indicative of the efficiency of the spreading while Rq may be indicative of the qualitative aspect of the layer. The optimum values for Vs and Rq depend on the AM application. To calculate Vs, the mean height of the spread layer in the sampling region may be multiplied by the spreader translation speed U. Rq may be the standard deviation of the heights occupied by the spread layer in the sampling region. These spread layers over a flat substrate can be seen to have voids which result in porosity in the 3D printed part and can eventually cause failure of the part during loading due to stress concentrations. The procedures which follow may be used to find spreading parameters which reduce the porosity in the 3D printed part.

The physics-based simulation results, as discussed above, may be highly nonlinear and the simulation time, per spreading simulation, may be quite high to perform a parametric study covering the entire range of spreader translation and rotation speeds, thereby resulting in a better understanding of the effect of these speeds on the spread layer parameters Vs and Rq. This problem is well suited to be solved using machine learning techniques to regress between the data obtained via design of spreading simulations from the previous section. In this exemplary embodiment, a neural network is used to perform the regression over the datasets since neural networks can generate an unbiased fit over a dataset than other regression techniques which require assumptions about the function of the surface to be regressed over the dataset.

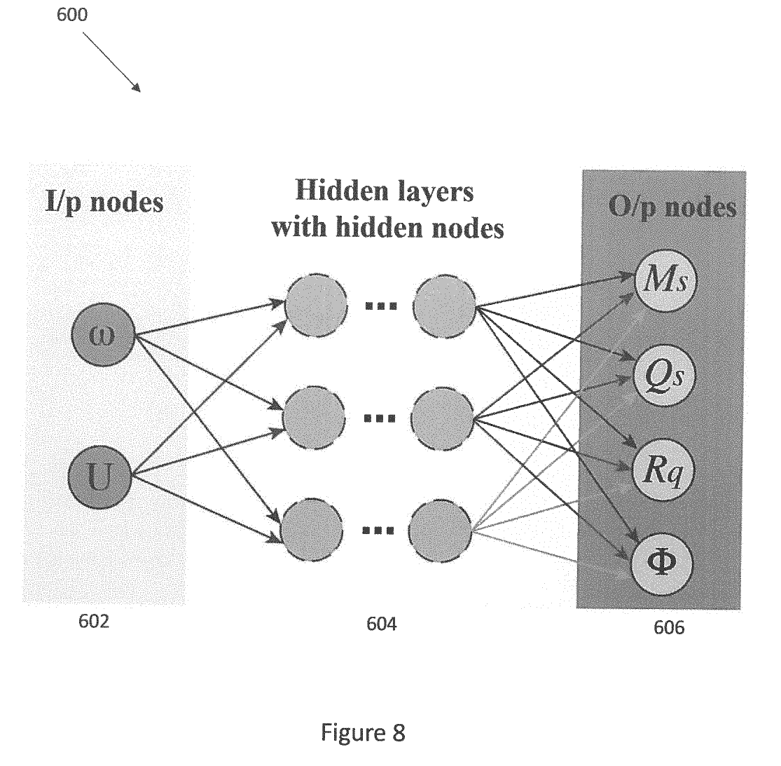

FIG. 8 illustrates a neural network 600. A neural network is a mathematical model of a biological neuron. In biological neurons, the dendrite receives electrical signals from the axons of other neurons; in the artificial neural network these electrical signals are represented as numerical values. Generally, there are three kinds of layers in a neural network, namely the input layer 602, hidden layer(s) 604, and the output layer 606. The input layer is a vector of values which are given as conditions in the problem. Similarly, the output layer is also a vector of values which are the target solutions for the problem.

In the case of studying the effect of spreader speeds on the spread layer, the input layer vector is spreader translation speed U and spreader rotation speed [symbol] and the output layer vector is made of spread layer parameters Vs and Rq, as defined in the previous section. There may be a single hidden layer or multiple hidden layers in the network based on how the constructor defines the network. For this study, the neural network comprises of a single hidden layer. Within each hidden layer, a vector of values is calculated using the data from the previous layer and these values are generated by the network to represent some feature of the data. Each layer is connected with the next layer using weights. These weights form a matrix of linear factors. The product of the vector from a certain layer and the weights matrix is the vector of the next layer. This means that each node in the next layer is a linear combination of nodes from the previous layer. However, this network has only linear functions. Many real problems often have complex nonlinear relationships between input and output. So, a nonlinear activation function is commonly used to make the network nonlinear and allow for the learning of rather complicated problems.

In the present example, a sigmoid function, defined as:

$$f ( x ) = \frac{1}{1 + {e}^{- x}} or f ( x ) = {tan}^{- 1} ( x )$$

may be used as an activation function. As the structure of the neural network has been defined, a useful way to train the network is back propagation (BP). In this training method, the target is the loss function which is commonly written as:

$$L = \frac{1}{N} {\sum }_{i = 1}^{N} {‖ {Y}_{i} - {O}_{i} ‖}^{2}$$

where N is the total number of training data. Yᵢ is the actual output vector for the i^{th} training data. Oᵢ is the target output vector for the i^{th} training data. The loss function is implemented to find the difference between the real output and the target output. Therefore the training process is actually finding the minimum of the loss function. Here, gradient descent algorithm is implemented to minimize the loss function. The loss function can be regarded as a complex nonlinear function. A random initial point can be defined and the direction where the function has the fastest decreasing speed can be found by calculating the derivative on that point. Then a step along the function is taken with a fixed step size and the new point is acquired. Iterating many times in this fashion, the point will get closer and closer to the minimum point.

For the training of the neural network, first, the weights are randomly generated. Then outputs are calculated from the inputs and the random weights. Finally, the loss function value can be obtained and used as the updates for the weight:

W⁽ⁿ⁺¹⁾=W⁽ⁿ⁾−αΔW

where

$$Δ W = \frac{\partial L}{\partial W}$$

In the above equations, α is the learning rate which will control the step size of gradient descent in each iteration. If α is too small, it may take a large number of iterations for the loss function to come to convergence. However, if α is too large the learning process may crash when the network is training. Oscillations will occur on the loss function value for each iteration.

Another main challenge of training the network is overfitting where the training error is decreasing but test error is increasing. Usually the reason is that the complexity of the network becomes much higher than the data itself and the weights have large magnitude. Hence L-2 regularization is implemented in the loss function to avoid overfitting:

$$L = \frac{1}{N} {\sum }_{i = 1}^{N} {‖ {Y}_{i} - {O}_{i} ‖}^{2} + λ {‖ W ‖}^{2}$$

In the new loss function, the norm of all the weight is put into the loss function and λ is the parameter to control the level of regularization. In this way, as the loss function decreases, the magnitude of all the weights is secured to be small.

The parameters used for back propagation neural network (BP-NN) used to regress between the spreader speeds and spread layer parameters in this exemplary embodiment are listed in Table 2. The number of hidden nodes was decided by conducting a parametric study involving BP-NNs with increasing number of hidden nodes and 200 was chosen as a tradeoff between accuracy and computational efficiency. The learning rate and L2-regularization parameter may also be chosen by conducting numerical experiments. The surfaces predicted by this machine learning model blanket the simulation data points, both training and test data points, generated via the Design of Simulations.

The results of the Design of Simulations may be delivered to a 3D printer via a spreading process map. This process map may relate the 3D printer spreader parameters of translation U and rotational ω speeds to the spread layer parameters of Vs and Rq. The Rq of the spread layer increases as the rotation of spreader changes from anticlockwise (+) to clockwise (−) direction. This is due to the clockwise spreader rotation forcing spread of multiple layers as opposed to only one to two layers in the cases of no and anticlockwise rotational motion. For a constant rotational speed ω, the efficiency of spread increases at the translational speed U, increases. Conversely, the most efficient way to spread a layer, which is indicated by a larger Vs, of known roughness is to obtain the rightmost U-ω pair on the process map.

The embodiment described above is exemplary, and one skilled in the art will recognize that the general process outlined in FIGS. 2-3 may be implemented using numerous different types of virtual experiments. The use of virtual experiments or simulations not explicitly described in the embodiment above should not be considered a departure from the scope of the present disclosure.

Embodiments of the methods and equipment disclosed herein may present advantages over state-of-the-art 3D printers. They may improve the spreading of powder layers by 3D printers by allowing 3D printers to use a variety of powders, including powders which have not previously been used for 3D printing. They may also decrease the time and material required to determine the necessary settings for printing with a particular powder, thereby decreasing the time and cost of printing jobs. They may also improve the quality of 3D printed products. Equipment and methods disclosed herein may also provide access to information such as the powder spreading process in AM, which is difficult to experimentally study.

While the disclosure includes a limited number of embodiments, those skilled in the art, having benefit of this disclosure, will appreciate that other embodiments may be devised which do not depart from the scope of the present disclosure. Accordingly, the scope should be limited only by the attached claims.

### Nomenclature

### Symbols

eₜ Unit vector along the tangential direction
K Stiffness of spring in a spring-dashpot system
L Loss function
m Mass
N Total number of training samples
R Correlation coefficient
Rq Roughness of spread layer or substrate
U Translation speed of the spreader
V Speed
Vs Volume of powder spread per unit time per unit width of spreader
Y, O Actual and target output vectors respectively

### Subscripts

n, t Subscripts: normal and tangential directions respectively
pp, pv, pi Collisions occurring between a particle (p) and another particle (p), cylindrical vessel (v) or impeller blade (i) respectively

### Greek Letters

α Learning rate
β Damping of dashpot in a spring-dashpot system
Δ Overlap of a particle with another particle or geometry
ε Coefficient of restitution
λ Regularization parameter
μ Coefficient of sliding friction
ϕ Diameter of a spherical particle
ρ Mass density of the particle in a particulate media
ω Rotational speed of the spreader

### Acronyms

AM Additive Manufacturing
DEM Discrete Element Method
P-STAC Particle-Surface Tribology Analysis Code

What is claimed is:

1. A method of generating parameters to guide a spreading process of a three dimensional printer, the method comprising:
determining one or more properties of an actual powder;
generating a virtual powder model which mimics the actual powder;
performing one or more virtual spreading simulations;
experimentally validating virtual spreading; and
using advanced regression techniques to generate spreading process map from a few virtual spreading simulations.

2. The method of claim 1, further comprising generating a spreading process map from the parameters to guide the spreading process.

3. The method of claim 1, wherein determining one or more properties of an actual powder comprises using a rheometer to measure one or more properties of the actual powder.

4. The method of claim 3, wherein the properties are an angle of repose and a flow energy.

5. The method of claim 4, wherein the angle of repose and the flow energy are functions of force and torque.

6. The method of claim 1, wherein the advanced regression techniques comprise machine learning.

7. The method of claim 1, wherein generating a virtual powder model comprises modeling the behavior of the virtual powder in a virtual rheometer.

8. The method of claim 1, wherein an angle of repose and the flow energy of the virtual powder model are similar to an angle of repose and a flow energy of the actual powder.

9. The method of claim 1, wherein the virtual powder model comprises of one damped Hookean spring and a frictional slider.

10. The method of claim 1, wherein performing one or more virtual spreading simulations comprises performing simulations in which one or more of the following parameters differs: a geometry or shape of a spreader, a tangential speed of a spreader, a rotational velocity of a spreader, a spread layer height and a roughness of a substrate surface.

11. The method of claim 1, wherein the step of performing one or more virtual spreading simulations is performed iteratively.

12. The method of claim 1, further comprising experimentally validating virtual spreading using miniaturized single layer spreading setup serving as a retrofit to a real three dimensional printer.

13. The method of claim 1, wherein using advanced regression techniques comprises using a neural network.

14. The method of claim 2, further comprising delivering the spreading process map to the 3D printer.

15. A three-dimensional printer configured to print a product from a powder, and configured to receive parameters to guide the spreading process, wherein the parameters are determined by the following method:
determining one or more properties of an actual powder;
generating a virtual powder model which mimics the actual powder;
performing one or more virtual spreading simulations;
experimentally validating virtual spreading; and
using advanced regression techniques to generate spreading process map from a few virtual spreading simulations

16. The three-dimensional printer of claim 15 wherein the parameters are received as a spreading process map.

17. The three-dimensional printer of claim 15, further comprising a sample spreading set-up, wherein the sample spreading set-up comprises a sample platform.

18. The three-dimensional printer of claim 17, wherein a spreading test coupon configured to receive a single layer of powder is disposed on the sample platform.
